(19) United States
(12) Patent Application Publication
(10) Pub. No.: US 2024/0356410 A1
(43) Pub. Date: Oct. 24, 2024

(54) SETTING METHOD FOR A GENERATOR STATOR RADIAL AIR CHANNEL OF A PERMANENT MAGNET SYNCHRONOUS GENERATOR

(71) Applicant: North China Electric Power University (Baoding), Baoding (CN)

(72) Inventors: Yuling HE, Baoding (CN); Wen ZHANG, Baoding (CN); Yifan BAI, Baoding (CN); Yong LI, Baoding (CN); Xiangao LIU, Baoding (CN)

(73) Assignee: North China Electric Power University (Baoding), Baoding (CN)

(21) Appl. No.: 18/539,316

(22) Filed: Dec. 14, 2023

(30) Foreign Application Priority Data
Apr. 23, 2023 (CN) 202310439733.4

(51) Int. Cl. H02K 9/02; G06F 30/20; G06F 119/08

(52) U.S. Cl. CPC H02K 9/02; G06F 30/20; G06F 2119/08; H02K 2213/03

(57) ABSTRACT

A setting method for a generator stator radial air channel of a permanent magnet synchronous generator belongs to the field of motor technology. In the case of a constant section radial air channel, the adjacent spacing of the radial air channel is changed, and the equal spacing distribution is changed to the unequal spacing distribution. By analyzing the temperature change, the local optimal scheme 1 is determined. On the basis of the local optimal scheme, the size of the radial air channel is changed, and the temperature is analyzed to determine the optimal air channel size, which is the local optimal scheme 2. The equal section radial air channel structure is changed into an unequal section segmented air channel structure, and the local optimal scheme 3 is determined as the global optimal scheme. The setting method effectively reduces thermal damage of the stator winding insulation caused by high temperatures.

### CROSS REFERENCE TO THE RELATED APPLICATIONS

This application is based upon and claims priority to Chinese Patent Application No. 202310439733.4, filed on Apr. 23, 2023, the entire contents of which are incorporated herein by reference.

### TECHNICAL FIELD

The invention relates to the field of motor technology, in particular to a setting method for a generator stator radial air channel of a permanent magnet synchronous generator.

### BACKGROUND

In recent years, as wind power generation has gradually become a new trend in global energy development, permanent magnet synchronous generators have been widely used in offshore and onshore wind power generation. At the same time, the expansion of the installed capacity and electromagnetic load of the wind turbine has caused the excessive temperature rise of the generator, which has brought about the problem of difficult heat dissipation inside the generator, which is also a key factor restricting the further development of wind power generation.

The permanent magnet wind turbine mainly comprises stator and rotor, stator winding, permanent magnets, casing, and other additional structures, and the internal structure is complex and compact. Usually, the heat dissipation of the generator mainly depends on the heat conduction between the stator and rotor and the heat exchange between the air gap. When the generator temperature rises and the heat dissipation is not in time, it is bound to cause a series of thermal fault problems. On the one hand, when the temperature is too high, it will cause the instability of the permanent magnet performance, and even demagnetization and demagnetization; at the same time, the temperature directly affects the life of the insulating material; when the temperature is too high to exceed the critical value, the winding insulation material is prone to brittle aging, and the insulation performance decreases. On the other hand, the temperature of the generator is unevenly distributed in the axial and radial directions, which easily leads to local overheating. Therefore, the temperature rise is a factor that cannot be ignored to ensure the normal operation of the generator. In order to reduce the influence of high temperature on the internal structure performance of the generator and improve the cooling effect of the generator, a reasonable design is necessary for the ventilating structure of the generator stator.

### SUMMARY

The purpose of the invention is to provide a setting method for a generator stator radial air channel of a permanent magnet synchronous generator to solve the existing problem that the generators do not dissipate heat easily.

In order to achieve the above purpose, the invention provides a setting method for a generator stator radial air channel of a permanent magnet synchronous generator, the permanent magnet synchronous generator comprises a generator casing, a stator core, and a rotor core arranged inside the generator casing, the rotor core is located inside the stator core. The stator core, the rotor core, and the generator casing are penetrated by a shaft, several permanent magnets are arranged on an outer surface of the rotor core, and air seams are arranged between the permanent magnets, a stator slot of the stator core is provided with several stator windings and several winding insulations, and an outer surface of the stator core is evenly distributed with several stator radial air channels, a bottom of the generator casing is provided with a generator base, and an outer surface of the generator casing are provided with cooling fins.

The setting method for the generator stator radial air channel comprises the following steps:
Step 1: setting n equal section radial air channels uniformly along an axial direction of the stator core without changing an original length of the stator core, dividing the stator core into n+1 equal thickness segments by the equal section radial air channels, an axial width of the equal section radial air channel is D₀, calculating a temperature field of a generator model of the equal section radial air channel with an equal spacing distribution, and analyzing a temperature variation law, taking a temperature field result as an original scheme OS, a total length of the stator core is L;
Step 2: on the basis of a stator core model established in Step 1, changing a distribution of the radial air channels on the stator core, and changing n equal section radial air channels to an unequal spacing distribution to maintain an axial size of the radial air channel, carrying out a temperature field simulation of the modified generator model to determine a local optimal scheme P1;
Step 3: under a determined air channel spacing distribution of the local optimal scheme P1, changing the axial width of the radial air channel, and designing an axial size from Dₘᵢₙ to Dₘₐₓ within a reasonable range, and increasing a step size by d in turn; carrying out a temperature field simulation of each equal section radial air channel with modified axial size, and determining a local optimal scheme P2 by comparison;
Step 4: recording an optimal axial size of the equal section radial air channels determined in the local optimal scheme P2 as d_{z}, and changing the equal section radial air channels into an unequal section segmented air channel structure, analyzing an influence law of the radial air channels on a temperature field of the generator stator core under different segments, and determining an optimal segment number, compared with the local optimal scheme P2, determining a scheme with a lowest temperature of stator windings as a local optimal scheme P3, increasing an axial size of the unequal section segmented air channel structure from dₘᵢₙ to dₘₐₓ, and the step size of each segment is s, a height of each radial air channel is an equal part of a radial length of the stator core;
Step 5: the local optimal scheme P3 determined above is a global optimal scheme, denoted as GS.

Preferably, specific steps of Step 2 are as follows: in Step 1, setting n equal section radial air channels, dividing the stator core equally into n+1 segments, an axial length of the stator core is L, and a length of each stator core is (L−n*D₀)/(n+1); on the basis, changing the length of each stator core, taking an initial axial size D₀ of the radial air channel as a measurement;
the radial air channels of the stator core are symmetrically distributed on both sides of an axial center of the stator, when the number of radial air channels is n, a number of stator core segments is n+1, and the number of stator core segments on one side is (n+1)/2, the number of stator core segments is measured first from the center to both sides, from the first segment to the (n+1)/2 segment, respectively;
when n is an odd number and the stator core is divided into segments in an even number, that is, when (n+1)/2 is an integer, the length of the stator core from the first segment to the [(n+1)/2] segment is as follows:

$$( L - n * {D}_{0} ) / ( n + 1 ) - [ ( n - 1 ) / 4 ] * {D}_{0} , ( L - n * {D}_{0} ) / ( n + 1 ) - [ ( n - 1 ) / 4 - 1 ] * {D}_{0} , ( L - n * {D}_{0} ) / ( n + 1 ) - [ ( n - 1 ) / 4 - 2 ] * {D}_{0} , ( L - n * {D}_{0} ) / ( n + 1 ) - [ ( n - 1 ) / 4 - 3 ] * {D}_{0} , … ( L - n * {D}_{0} ) / ( n + 1 ) - [ ( n - 1 ) / 4 - k ] * {D}_{0} ;$$

$$where k = 0 , 1 , 2 , 3 , … , ( n + 1 ) / 2 - 1 ;$$

when n is an even number and the stator core is divided into segments in an odd number, that is, when (n+1)/2 is a fraction, the length of the stator core from the first segment to the ┌(n+1)/2┐ segment is as follows:

$$( L - n * {D}_{0} ) / ( n + 1 ) , ( L - n * {D}_{0} ) / ( n + 1 ) - [ ( n - 2 ) / 4 - 1 ] * {D}_{0} , ( L - n * {D}_{0} ) / ( n + 1 ) - [ ( n - 2 ) / 4 - 1 ] * {D}_{0} , ( L - n * {D}_{0} ) / ( n + 1 ) - [ ( n - 2 ) / 4 - 2 ] * {D}_{0} , ( L - n * {D}_{0} ) / ( n + 1 ) - [ ( n - 2 ) / 4 - 3 ] * {D}_{0} , … ( L - n * {D}_{0} ) / ( n + 1 ) - [ ( n - 2 ) / 4 - k ] * {D}_{0} ;$$

k takes rounding downward, where k=0, 1, 2, 3, . . . , └(n+1)/2−1┘;
a length of each segment of the stator core is constrained by the total length of the stator core and the axial width of the radial air channel.

Preferably, specific steps of Step 4 are as follows: recording an optimal axial size of the equal section radial air channels determined in the local optimal scheme P2 as d_{z}, on the basis, dividing the unequal section segmented air channel structure into m segments, increasing the axial size from dₘᵢₙ to dₘₐₓ, and the step size of each segment is s, an axial size of the segmented radial air channel is as follows:
when m is an odd number, the section width of each segment of the radial air channel is as follows:

$${d}_{𝓏} - [ ( m - 1 ) / 2 ] * s , {d}_{𝓏} - [ ( m - 1 ) / 2 - 1 ] * s , {d}_{𝓏} - [ ( m - 1 ) / 2 - 2 ] * s ,$$

$${d}_{𝓏} - [ ( m - 1 ) / 2 - 3 ] * s , … , {d}_{𝓏} , {d}_{𝓏} + s , {d}_{𝓏} + 2 s , {d}_{𝓏} + 3 s , {d}_{𝓏} + [ ( m - 1 ) / 2 ] * s ;$$

when m is an even number, the section width of each segment of the radial air channel is as follows:

$${d}_{𝓏} - [ ( m - 1 ) / 2 ] * s , {d}_{𝓏} - [ ( m - 1 ) / 2 - 1 ] * s , {d}_{𝓏} - [ ( m - 1 ) / 2 - 2 ] * s , {d}_{𝓏} - [ ( m - 1 ) / 2 - 3 ] * s , … , {d}_{𝓏} - 1.5 s , {d}_{𝓏} - 0.5 s , {d}_{𝓏} + 0.5 s , {d}_{𝓏} + 1.5 s , {d}_{𝓏} + 2.5 s , {d}_{𝓏} + [ ( m - 1 ) / 2 ] * s .$$

Preferably, on the basis of the equal section radial air channels, changing a cross section size by adding a stator core ring punching structure in the radial air channel of the stator core, determining a diameter of the stator core ring punching according to the radial segment number m of the radial air channel, and determining a thickness of the stator core ring punching according to a cumulative step size.

Preferably, carrying out a temperature field analysis of the modified radial air channel structure, and selecting the local optimal scheme and the global optimal scheme with a goal of minimizing a temperature of the generator and the stator winding.

Therefore, the invention discloses a setting method for a generator stator radial air channel of a permanent magnet synchronous generator, it can study the influence of radial air channel size, spacing distribution, and air channel cross section area on the generator temperature field; by changing the section width, the radial air channel is in a ladder form. Under the condition that the cooling air volume is constant, the structure can improve the flow velocity of the air in the small air channels; in the process of air passing through the radial air channel, the decrease of the width promotes the increase of the air flow velocity, improves the heat dissipation efficiency and the uniformity of the overall temperature distribution of the generator.

The following is a further detailed description of the technical solution of the invention through drawings and an embodiment.

### BRIEF DESCRIPTION OF THE DRAWINGS

FIG. 1 is a flow chart of the embodiment of the setting method for generator stator radial air channels of the permanent magnet synchronous generator in the invention.

FIG. 2 is an internal structure diagram of the permanent magnet synchronous generator in the setting method for generator stator radial air channels of the permanent magnet synchronous generator in the invention.

FIG. 3 is a structural diagram of the stator core and the rotor core of the setting method for generator stator radial air channels of the permanent magnet synchronous generator in the invention.

FIG. 4 is a structural diagram of the equal spacing radial air channel structure of the permanent magnet synchronous generator in the invention.

FIG. 5 is the upper segment diagram of the equal spacing radial air channel structure of the permanent magnet synchronous generator in the invention.

FIG. 6 is an A-A cross section of FIG. 5;

FIG. 7 is a structural diagram of the unequal spacing radial air channel of the permanent magnet synchronous generator in the invention;

FIG. 8 is a structural diagram of the two-segment radial air channel of the permanent magnet synchronous generator in the invention.

FIG. 9 is the structural diagram of the three-segment radial air channel of the permanent magnet synchronous generator in the invention.

Marks in the figures: 1, generator casing; 2, stator core; 3, rotor core; 4, shaft; 5, permanent magnet; 6, air seam; 7, stator winding; 8, winding insulation; 9, stator radial air channel; 10, generator base; 11, generator casing cooling fin.

### DETAILED DESCRIPTION OF THE EMBODIMENTS

The following is a further explanation of the technical solution of the invention through drawings and an embodiment.

Unless otherwise defined, the technical terms or scientific terms used in the invention should be understood by people with general skills in the field to which the invention belongs. The words ‘first’, ‘second’, and the like used in this invention do not represent any order, quantity, or importance, but are only used to distinguish different components. Similar words such as ‘comprise’ or ‘include’ mean that the elements or objects appearing before the word cover the elements or objects listed after the word and their equivalents, without excluding other elements or objects. Similar terms such as ‘connected’ or ‘connect’ are not limited to physical or mechanical connections, but can include electrical connections, whether direct or indirect. ‘Up’, ‘down’, ‘left’, ‘right’, etc. are only used to represent the relative positional relationship, when the absolute position of the described object changes, the relative positional relationship may also change accordingly.

### EMBODIMENT

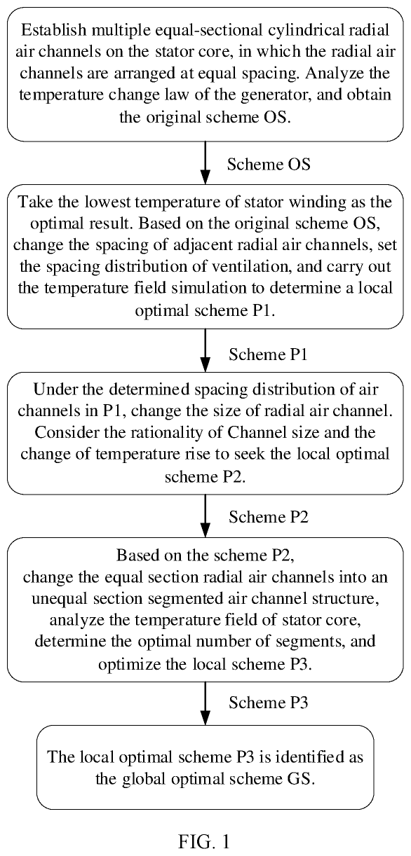

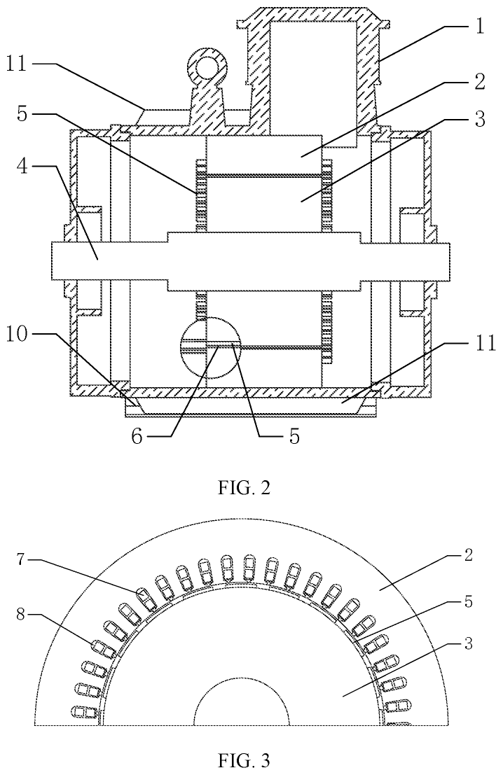

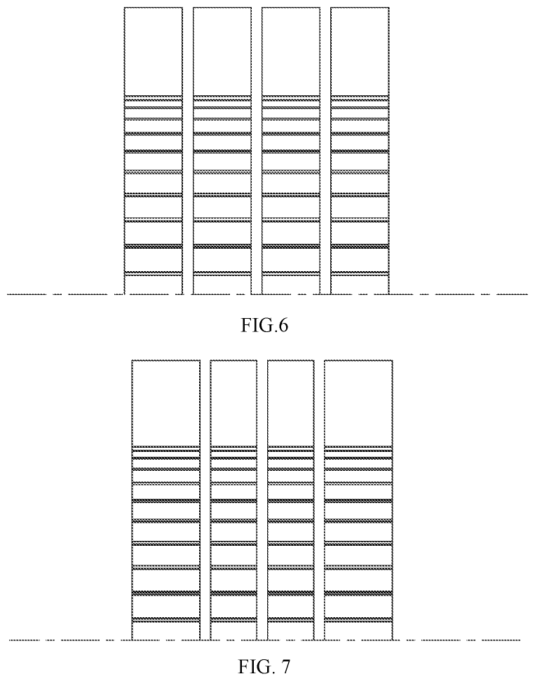

Please refer to FIGS. 1-9, the invention provides a setting method for a generator stator radial air channel of a permanent magnet synchronous generator, the permanent magnet synchronous generator comprises the generator casing 1, and the stator core 2 and the rotor core 3 arranged inside the generator casing 1, the rotor core 3 is located inside the stator core 2, the stator core 2, the rotor core 3 and the generator casing 1 are penetrated by the shaft 4, several permanent magnets 5 are arranged on an outer surface of the rotor core 3, and air seams 6 are arranged between the permanent magnets 5, the stator slot of the stator core 2 is provided with several stator windings 7 and several winding insulations 8, and the outer surface of the stator core 2 is evenly distributed with several stator radial air channels 9, the bottom of the generator casing 1 is provided with the generator base 10, and the outer surface of the generator casing 1 are provided with cooling fins 11.

The setting method for the generator stator radial air channel comprises the following steps:
Step 1: n equal section radial air channels are set uniformly along the axial direction of the stator core without changing the original length of the stator core, the stator core is divided into n+1 equal thickness segments by the equal section radial air channels, the axial width of the equal section radial air channel is D₀, the temperature field of the generator model of the equal section radial air channel with the equal spacing distribution is calculated, and the temperature variation law is analyzed, the temperature field result is taken as the original scheme OS, the total length of the stator core is L; the original length of the stator core is not changed by the established n radial air channels, and the original length is not changed;
Step 2: on the basis of a stator core model established in Step 1, the distribution of the radial air channels on the stator core is changed, and n equal section radial air channels are changed into the unequal spacing distribution, the above modification does not change the axial size of the radial air channel; the temperature field simulation of the modified generator model is carried out to determine the local optimal scheme P1 with the objective of reducing the stator winding temperature;
Step 3: under the determined air channel spacing distribution of the local optimal scheme P1, the axial width of the radial air channel is changed, and the axial size from Dₘᵢₙ to Dₘₐₓ is designed within a reasonable range, and the step size is increased by d in turn; the temperature field simulation of each equal section radial air channel with modified axial size is carried out, and the local optimal scheme P2 is determined by comparison;
Step 4: the optimal axial size of the equal section radial air channels determined in the local optimal scheme P2 is recorded as d_{z}, and the equal section radial air channels are changed into the unequal section segmented air channel structure, the influence law of the radial air channels on the temperature field of the generator stator core under different segments is analyzed, and the optimal segment number is determined, compared with the local optimal scheme P2, the scheme with the lowest temperature of stator windings is determined as the local optimal scheme P3, the axial size of the unequal section segmented air channel structure is increased from dₘᵢₙ to dₘₐₓ, and the step size of each segment is s, the height of each radial air channel is the equal part of the radial length of the stator core;
Step 5: the local optimal scheme P3 determined above is the global optimal scheme, denoted as GS.

The specific steps of Step 2 are as follows: in Step 1, n equal section radial air channels are set, the stator core is equally divided into n+1 segments, the axial length of the stator core is L, and the length of each stator core is (L−n*D₀)/(n+1); on the basis, the length of each stator core is changed, the initial axial size D₀ of the radial air channel is taken as a measurement;
considering the structure of the permanent magnet wind turbine, the radial air channels of the stator core are symmetrically distributed on both sides of an axial center of the stator, when the number of radial air channels is n, the number of stator core segments is n+1, and the number of stator core segments on one side is (n+1)/2, the number of stator core segments is measured first from the center to both sides, from the first segment to the (n+1)/2 segment, respectively;
when n is an odd number and the stator core is divided into segments in an even number, that is, when (n+1)/2 is an integer, the length of the stator core from the first segment to the [(n+1)/2] segment is as follows:

$$( L - n * {D}_{0} ) / ( n + 1 ) - [ ( n - 1 ) / 4 ] * {D}_{0} , ( L - n * {D}_{0} ) / ( n + 1 ) - [ ( n - 1 ) / 4 - 1 ] * {D}_{0} , ( L - n * {D}_{0} ) / ( n + 1 ) - [ ( n - 1 ) / 4 - 2 ] * {D}_{0} , ( L - n * {D}_{0} ) / ( n + 1 ) - [ ( n - 1 ) / 4 - 3 ] * {D}_{0} , … ( L - n * {D}_{0} ) / ( n + 1 ) - [ ( n - 1 ) / 4 - k ] * {D}_{0} ;$$

$$where k = 0 , 1 , 2 , 3 , … , ( n + 1 ) / 2 - 1 ;$$

when n is an even number and the stator core is divided into segments in an odd number, that is, when (n+1)/2 is a fraction, the length of the stator core from the first segment to the ┌(n+1)/2┐ segment is as follows:

$$( L - n * {D}_{0} ) / ( n + 1 ) , ( L - n * {D}_{0} ) / ( n + 1 ) - [ ( n - 2 ) / 4 - 1 ] * {D}_{0} , ( L - n * {D}_{0} ) / ( n + 1 ) - [ ( n - 2 ) / 4 - 1 ] * {D}_{0} , ( L - n * {D}_{0} ) / ( n + 1 ) - [ ( n - 2 ) / 4 - 2 ] * {D}_{0} , ( L - n * {D}_{0} ) / ( n + 1 ) - [ ( n - 2 ) / 4 - 3 ] * {D}_{0} , … ( L - n * {D}_{0} ) / ( n + 1 ) - [ ( n - 2 ) / 4 - k ] * {D}_{0} ;$$

k takes rounding downward, where k=0, 1, 2, 3, . . . , └(n+1)/2−1┘.
the length of each segment of the stator core is constrained by the total length of the stator core and the axial width of the radial air channel.

The specific steps of Step 4 are as follows: the optimal axial size of the equal section radial air channels determined in the local optimal scheme P2 is recorded as d_{z}, on the basis, the unequal section segmented air channel structure is divided into m segments, the axial size is increased from dₘᵢₙ to dₘₐₓ, and the step size of each segment is s, the axial size of the segmented radial air channel is as follows:
when m is an odd number, the section width of each segment of the radial air channel is as follows:

$${d}_{𝓏} - [ ( m - 1 ) / 2 ] * s , {d}_{𝓏} - [ ( m - 1 ) / 2 - 1 ] * s , {d}_{𝓏} - [ ( m - 1 ) / 2 - 2 ] * s ,$$

$${d}_{𝓏} - [ ( m - 1 ) / 2 - 3 ] * s , … , {d}_{𝓏} , {d}_{𝓏} + s , {d}_{𝓏} + 2 s , {d}_{𝓏} + 3 s , {d}_{𝓏} + [ ( m - 1 ) / 2 ] * s ;$$

when m is an even number, the section width of each segment of the radial air channel is as follows:

$${d}_{𝓏} - [ ( m - 1 ) / 2 ] * s , {d}_{𝓏} - [ ( m - 1 ) / 2 - 1 ] * s , {d}_{𝓏} - [ ( m - 1 ) / 2 - 2 ] * s , {d}_{𝓏} - [ ( m - 1 ) / 2 - 3 ] * s , … , {d}_{𝓏} - 1.5 s , {d}_{𝓏} - 0.5 s , {d}_{𝓏} + 0.5 s , {d}_{𝓏} + 1.5 s , {d}_{𝓏} + 2.5 s , {d}_{𝓏} + [ ( m - 1 ) / 2 ] * s .$$

On the basis of the equal section radial air channels, the cross section size is changed by adding the stator core ring punching structure in the radial air channel of the stator core, the diameter of the stator core ring punching is determined according to the radial segment number m of the radial air channel, and the thickness of the stator core ring punching is determined according to the cumulative step size.

The temperature field analysis of each modified radial air channel structures is carried out, and the local optimal scheme and the global optimal scheme are selected with the goal of minimizing the temperature of the generator and the stator winding.

The lowest overall temperature of the generator means that the highest temperature of the generator with the optimal radial ventilating structure is the lowest compared with the temperature results of other schemes. The lowest temperature of the stator winding means that the highest temperature of the stator winding in the optimal scheme is the lowest compared with the temperature results of other schemes.

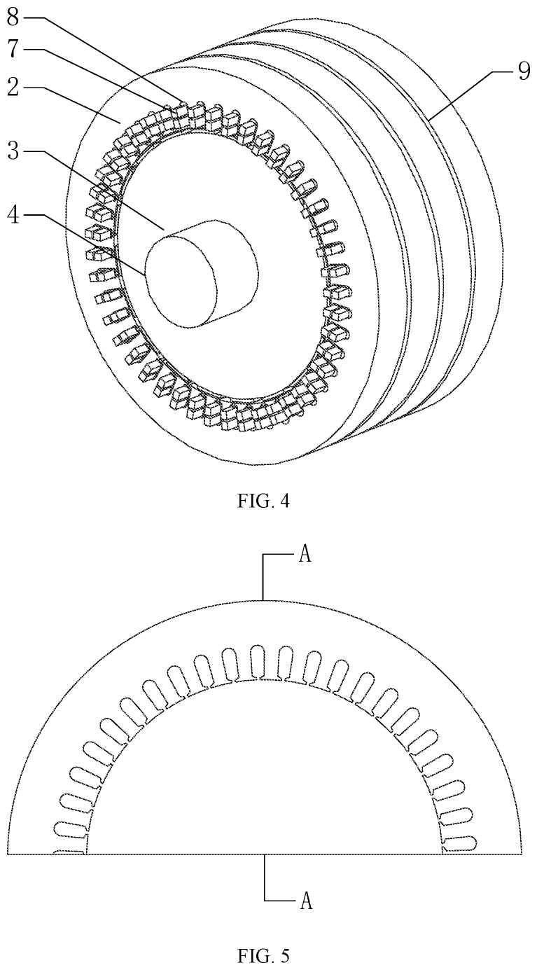

The generator parameters involved in FIG. 4 to FIG. 9 include: the generator stator core length L=120 mm, and the stator outer circle radius R=130 mm; because the ratio of axial and radial length of the generator stator in this embodiment is relatively small, the number of radial air channels is n=3, the step size in Step 3 is increased by d=1 mm, and the step size in Step 4 is s=2 mm.

The optimization method for the stator radial air channel structure of the permanent magnet synchronous generator in this implementation case is optimized according to the attached FIG. 1.

Step 1: FIG. 2 is an internal structure diagram of the permanent magnet generator without structural optimization. Based on this structure, three equal section radial air channels are evenly set on the stator core, and the axial width of the air channel is set to D₀=5 mm; without changing the original total length, the stator core is divided into four stator core segments, each of which has a length of 26.25 mm, as shown in FIG. 4 and FIG. 5. The model is used as the original model for temperature field simulation analysis, and the temperature result is used as the original scheme, which is recorded as OS.

Step 2: The equal spacing radial air channels are changed into unequal spacing radial air channels, while the two dimensions are not changed, that is, the number of radial air channels n=3 and the axial width of the air channel D₀=5 mm. The stator core of the generator is divided into four core segments with unequal widths by using the method described in the invention. In this embodiment, the stator core segment is divided into even segments, (n+1)/2=2 is an integer, k=0 or 1. The thickness of the four stator core segments is central axisymmetric, which can be seen in FIG. 7. The thicknesses are as follows: 28.75 mm, 23.75 mm, 23.75 mm, and 28.75 mm. The temperature simulation of the modified stator core structure is compared with the results of the original scheme OS, and the local optimal scheme P1 is selected.

Step 3: By comparing the temperature results in Step 2, the stator core is divided into different thicknesses, on the one hand, the heat capacity accumulation of the stator core and winding loss in the middle area of the generator is improved, on the other hand, the temperature distribution along the axis is more uniform. Therefore, the stator core structure with different thicknesses is determined as the optimal scheme P1.

On the basis of P1, D₀ is changed, and a series of radial air channel widths are designed with step length d=1 mm. The width values are as follows: 3 mm, 4 mm, 5 mm, 6 mm. The temperature analysis of the above four schemes is carried out, considering the lowest temperature of the stator winding and the lowest thermal damage of the stator winding insulation, the temperature result of the ventilating structure with a width of 4 mm is optimal, which is the local optimal scheme P2.

Step 3: the equal section radial air channel is changed into an unequal section segmented air channel structure.

The specific process of the steps is as follows: Based on the above local optimal scheme P2, the optimal axial width is recorded as d_{z}, the section width of each segment of the segmented radial air channel is designed on the basis, and the step size of each segment is set to s=2 mm.

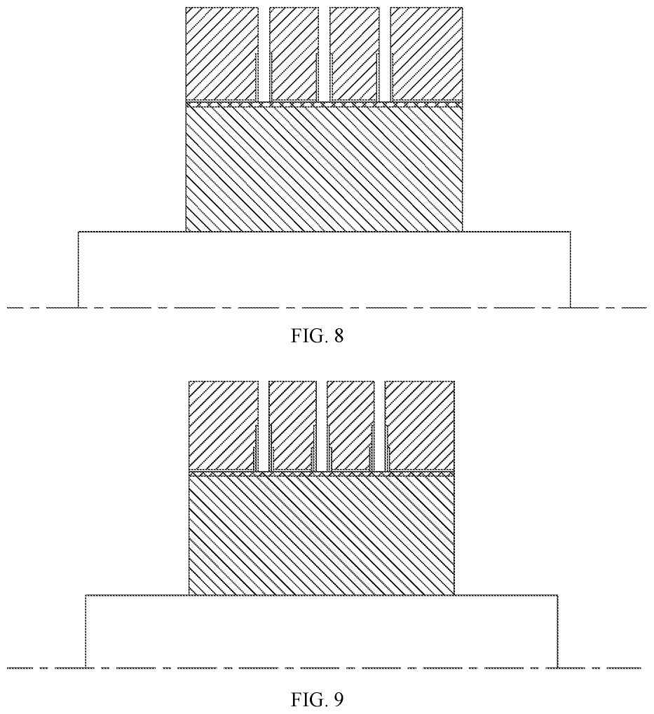

The width of the two-segment radial air channel is as follows: d_{z}−0.5s, d_{z}+0.5s; where d_{z}=4 mm, that is, the width is as follows: 3 mm, 5 mm, as shown in FIG. 8.

The width of the three-segment radial air channel is as follows: d_{z}−s, d_{z}, d_{z}+s; the width is: 2 mm, 4 mm, 6 mm, as shown in FIG. 9.

The segmented radial air channel ensures that the overall ventilation volume is not changed, and only the size of the ventilation contact area with the air changes.

The temperature field simulations of the above two structures are carried out, compared with the two-segment radial ventilating structure and the traditional radial ventilating structure, the three-segment radial ventilating structure not only increases the ventilation area but also increases the pressure and flow rate of the air in the air channel with a stepped change in the axial width, which effectively reduces the temperature of generator stator. Therefore, it is determined as the local optimal scheme, that is, the global optimal scheme GS.

Finally, the global optimal scheme determined in this embodiment is as follows: the three-segment radial air channel with unequal spacing, and the axial dimensions of each segment are 2 mm, 4 mm, and 6 mm respectively.

Therefore, the invention adopts the setting method for a generator stator radial air channel of a permanent magnet synchronous generator with the above structure. The content is simple and easy to implement. From the local optimum to the global optimum, the selection method of the optimal size of the generator radial air channel is introduced in detail. It effectively accelerates the convective heat transfer between the stator core and the air of the generator, improves the temperature distribution of the generator along the axial direction, reduces the temperature of the stator winding, and reduces the thermal damage effect of the high temperature on the insulation material of the stator winding.

Finally, it should be explained that the above embodiment is only used to illustrate the technical solution of the invention rather than restrict it. Although the invention is described in detail with reference to the better embodiment, the ordinary technical personnel in this field should understand that they can still modify or replace the technical solution of the invention, and these modifications or equivalent substitutions cannot make the modified technical solution out of the spirit and scope of the technical solution of the invention.

What is claimed is:

1. A setting method for a generator stator radial air channel of a permanent magnet synchronous generator, the permanent magnet synchronous generator comprises a generator casing, a stator core, and a rotor core, wherein the stator core and the rotor core are arranged inside the generator casing, and the rotor core is located inside the stator core; the stator core, the rotor core, and the generator casing are penetrated by a shaft; a plurality of permanent magnets are arranged on an outer surface of the rotor core, and air seams are arranged between the plurality of permanent magnets; a stator slot of the stator core is provided with a plurality of stator windings and a plurality of winding insulations, and an outer surface of the stator core is evenly distributed with a plurality of stator radial air channels; a bottom of the generator casing is provided with a generator base, and an outer surface of the generator casing is provided with cooling fins;
wherein the setting method for the generator stator radial air channel comprises the following steps:
step 1: setting n equal section radial air channels uniformly along an axial direction of the stator core without changing an original length of the stator core, dividing the stator core into n+1 equal thickness segments by the n equal section radial air channels, an axial width of the equal section radial air channel is D₀, calculating a temperature field of a generator model of the equal section radial air channel with an equal spacing distribution, and analyzing a temperature variation law, taking a temperature field result as an original scheme OS, a total length of the stator core is L;
step 2: on the basis of a stator core model established in step 1, changing a distribution of the n equal section radial air channels on the stator core, and changing the n equal section radial air channels to an unequal spacing distribution to maintain an axial size of the radial air channel, carrying out a temperature field simulation of the modified generator model to determine a local optimal scheme P1;
step 3: under a determined air channel spacing distribution of the local optimal scheme P1, changing the axial width of the radial air channel, and designing an axial size from Dₘᵢₙ to Dₘₐₓ within a reasonable range, and increasing a step size by d in turn; carrying out a temperature field simulation of each equal section radial air channel with modified axial size, and determining a local optimal scheme P2 by comparison;
step 4: recording an optimal axial size of the n equal section radial air channels determined in the local optimal scheme P2 as d_{z}, and changing the n equal section radial air channels into an unequal section segmented air channel structure, analyzing an influence law of the radial air channels on a temperature field of the generator stator core under different segments, and determining an optimal segment number, compared with the local optimal scheme P2, determining a scheme with a lowest temperature of stator windings as a local optimal scheme P3, increasing an axial size of the unequal section segmented air channel structure from dₘᵢₙ to dₘₐₓ, and the step size of each segment is s, a height of each radial air channel is an equal part of a radial length of the stator core; and
step 5: the local optimal scheme P3 determined above is a global optimal scheme, denoted as GS.

2. The setting method for the generator stator radial air channel of the permanent magnet synchronous generator according to claim 1, wherein specific steps of step 2 are as follows: in step 1, setting the n equal section radial air channels, dividing the stator core equally into n+1 segments, an axial length of the stator core is L, and a length of each stator core is (L−n*D₀)/(n+1); on the basis, changing the length of each stator core, taking an initial axial size D₀ of the radial air channel as a measurement;
the radial air channels of the stator core are symmetrically distributed on both sides of an axial center of the stator, wherein when the number of radial air channels is n, a number of stator core segments is n+1, and the number of stator core segments on one side is (n+1)/2, the number of stator core segments is measured first from the center to both sides, from the first segment to the (n+1)/2 segment, respectively;
when n is an odd number and the stator core is divided into segments in an even number, that is, when (n+1)/2 is an integer, the length of the stator core from the first segment to the [(n+1)/2] segment is as follows:
$$( L - n * {D}_{0} ) / ( n + 1 ) - [ ( n - 1 ) / 4 ] * {D}_{0} , ( L - n * {D}_{0} ) / ( n + 1 ) - [ ( n - 1 ) / 4 - 1 ] * {D}_{0} , ( L - n * {D}_{0} ) / ( n + 1 ) - [ ( n - 1 ) / 4 - 2 ] * {D}_{0} , ( L - n * {D}_{0} ) / ( n + 1 ) - [ ( n - 1 ) / 4 - 3 ] * {D}_{0} , … ( L - n * {D}_{0} ) / ( n + 1 ) - [ ( n - 1 ) / 4 - k ] * {D}_{0} ;$$
wherein k=0, 1, 2, 3, . . . , (n+1)/2−1;
when n is an even number and the stator core is divided into segments in an odd number, that is, when (n+1)/2 is a fraction, the length of the stator core from the first segment to the ┌(n+1)/2┐ segment is as follows:
$$( L - n * {D}_{0} ) / ( n + 1 ) , ( L - n * {D}_{0} ) / ( n + 1 ) - [ ( n - 2 ) / 4 - 1 ] * {D}_{0} , ( L - n * {D}_{0} ) / ( n + 1 ) - [ ( n - 2 ) / 4 - 1 ] * {D}_{0} , ( L - n * {D}_{0} ) / ( n + 1 ) - [ ( n - 2 ) / 4 - 2 ] * {D}_{0} , ( L - n * {D}_{0} ) / ( n + 1 ) - [ ( n - 2 ) / 4 - 3 ] * {D}_{0} , … ( L - n * {D}_{0} ) / ( n + 1 ) - [ ( n - 2 ) / 4 - k ] * {D}_{0} ;$$
k takes rounding downward, wherein k=0, 1, 2, 3, . . . , └(n+1)/2−1┘; and
a length of each segment of the stator core is constrained by the total length of the stator core and the axial width of the radial air channel.

3. The setting method for the generator stator radial air channel of the permanent magnet synchronous generator according to claim 2, wherein specific steps of step 4 are as follows: recording the optimal axial size of the n equal section radial air channels determined in the local optimal scheme P2 as d_{z}, on the basis, dividing the unequal section segmented air channel structure into m segments, increasing the axial size from dₘᵢₙ to dₘₐₓ, and the step size of each segment is s, an axial size of the segmented radial air channel is as follows:
when m is an odd number, a section width of each segment of the radial air channel is as follows:
$${d}_{𝓏} - [ ( m - 1 ) / 2 ] * s , {d}_{𝓏} - [ ( m - 1 ) / 2 - 1 ] * s , {d}_{𝓏} - [ ( m - 1 ) / 2 - 2 ] * s ,$$
$${d}_{𝓏} - [ ( m - 1 ) / 2 - 3 ] * s , … , {d}_{𝓏} , {d}_{𝓏} + s , {d}_{𝓏} + 2 s , {d}_{𝓏} + 3 s , {d}_{𝓏} + [ ( m - 1 ) / 2 ] * s ;$$
when m is an even number, the section width of each segment of the radial air channel is as follows:
$${d}_{𝓏} - [ ( m - 1 ) / 2 ] * s , {d}_{𝓏} - [ ( m - 1 ) / 2 - 1 ] * s , {d}_{𝓏} - [ ( m - 1 ) / 2 - 2 ] * s , {d}_{𝓏} - [ ( m - 1 ) / 2 - 3 ] * s , … , {d}_{𝓏} - 1.5 s , {d}_{𝓏} - 0.5 s , {d}_{𝓏} + 0.5 s , {d}_{𝓏} + 1.5 s , {d}_{𝓏} + 2.5 s , {d}_{𝓏} + [ ( m - 1 ) / 2 ] * s .$$

4. The setting method for the generator stator radial air channel of the permanent magnet synchronous generator according to claim 3, further comprising: on the basis of the n equal section radial air channels, changing a cross section size by adding a stator core ring punching structure in the radial air channel of the stator core, determining a diameter of the stator core ring punching according to the radial segment number m of the radial air channel, and determining a thickness of the stator core ring punching according to a cumulative step size.

5. The setting method for the generator stator radial air channel of the permanent magnet synchronous generator according to claim 4, further comprising: carrying out a temperature field analysis of the modified radial air channel structure, and selecting the local optimal scheme and the global optimal scheme with a goal of minimizing a temperature of the generator and the stator winding.
